(19) United States
(12) Patent Application Publication
(10) Pub. No.: US 2008/0318488 A1
(43) Pub. Date: Dec. 25, 2008

(54) Deer rattling device

(76) Inventor: Michael Castner, Dallas, PA (US)

Correspondence Address: RICHARD L. BIGELOW, 203 TREMONT STREET, NEWINGTON, CT, 06111, US

(21) Appl. No.: 12/214,383

(22) Filed: Jun. 18, 2008

Related U.S. Application Data
(60) Provisional application No. 60/936,844, filed on Jun. 22, 2007.

(51) Int. Cl. A01M 31/00; A63H 5/00

(52) U.S. Cl. 446/26; 446/418

(57) ABSTRACT

A rattling device to replicate the sound of antlers of bucks engaged in combat. The device comprises a rounded base body assembly, a striker assembly, a flexible spring that holds the striker assembly and base base body together, a leg strap, and a belt hanger. The rounded base body and the striker assembly are made of molded plastic. The rounded base body assembly contains a series of variably sized hollow nodes. The striker assembly comprises a series of similarly sized hollow nodes. The device is manufactured such that the nodes of the base plate face the nodes of the striker assembly. In the rest position, the nodes are held firmly against each other by the force of the flexible spring. When the hunter wants to replicate the sound of bucks battling each other, the striker assembly is pulled away from the rounded base body. The flexible elastic spring provides a force that opposes the action of the hunter. When the hunter releases the striker assembly, the spring forces it back into base plate where the nodes of the striker assembly impinge on the nodes of the rounded base body making the sound of the initial thrust of two battling bucks. As the hunter pulls the striker assembly slightly away from the rounded base body and slightly rotates the striker assembly, a sound is replicated that simulates the sound of the antlers of battling bucks continuing to engage each other at close quarters. The base plate and striker assembly are injection molded. The nodes of the base plate and striker assembly are hollow. The nodes face each other. The device contains a leg strap and belt hanger to affix it to the hunter's body or clothing.

### CROSS REFERENCE TO RELATED APPLICATIONS

This Non-Provisional Application claims priority from U.S. Provisional Patent Application No. 60/936,844

### FEDERAL RESEARCH STATEMENT

None

### BACKGROUND OF THE INVENTION

This invention relates to a device to simulate the sound made by two bucks fighting. This sound is known as rattling and is indicative of two bucks engaging in combat. The sound of bucks in combat has been shown to attract other deer to the area. The instant device serves to attract deer to a hunter by simulating the sound of bucks fighting.

### DESCRIPTION OF THE PRIOR ART

The prior art teaches three distinct types of devices used to simulate the sound of bucks engaging in combat—electronic devices, bag devices, and the use of real horns.

U.S. Pat. No. 6,757,574 issued to William J. Gardner et al on Jun. 29, 2004 reflects the state of the art with respect to simulating or reproducing animal sounds for the purpose of attracting them to hunters. The device disclosed in the '574 patent is essentially a device that plays pre-recorded sound clips of various animals in various situation. Included in these sounds is that of bucks fighting.

U.S. Pat. No. 6,234,865 issued to Michael L. Battey on May 22, 2001 teaches a device that comprises various antler parts inserted into a bag. The '865 patent represents the state of the art with respect to bag rattling devices. Actual or simulated antler parts are placed into a bag that contains strips of material. As the bag is shaken, the antler parts interact with the strips and produce a sound simulating combat between bucks.

While both the above described devices are somewhat effective, they do have drawbacks. The electronic devices never quite reproduce the sound of bucks in combat while the rattling sound produced in the bag devices is somewhat muffled.

Neither of the patents described above or the referenced prior art, taken either singly or in combination, are seen to disclose the specific arrangement of concepts disclosed by the present invention.

### SUMMARY OF THE INVENTION

The present invention is directed toward a device that can be simply and easily used to simulate the rattling sound of the antlers of two bucks clashing against other during combat. It is a well known fact that the sound of antlers clashing attracts other deer to the area where the sound is being produced. As a hunter progresses through a forest or is perched in a deer stand, there is a requirement that he or she be able to simulate the sound of antlers clashing in order to attract deer to the area. There is a further requirement that the sound of clashing antlers be produced only when the hunter wants it to be produced and not at other inopportune times. The present invention meets all these requirements.

The present invention consists of a rattling device which comprises a rounded base body which contains a series of raised nodes and a facing striker assembly which also contains a series of raised nodes. The raised nodes on the rounded body and the striker assembly face each other. The device can be attached to the upper leg of a hunter with a leg strap and can further be attached to the hunter's belt by use of a belt hanger device. The nodes are of various sizes and shapes in order to produce antler-like sounds of varying pitches and intensity. The rounded base body and striker assembly are joined together, but held apart by a metallic elastic spring. When the hunter wants to simulate the sound of antlers engaged in combat, he or she presses the striker against the rounded base body and rotates the striker slightly. The raised nodes of the striker rub against the raised nodes of the rounded base body and produce a sound a sound that replicates the sound of buck antlers clashing. The hunter has the ability to produce the sound at varying volume levels and pitches for varying amounts of time.

The rounded plate and striker of the present invention can be made of any rigid material—i.e. metal, molded plastic, wood, etc. The nodes should be made of hard molded plastic or actual pieces of deer antlers. The spring should be made of a lightweight, yet strong and flexible material such as surgical tubing. The leg strap is made of cloth texture and has an adjustable clasp. The belt hanger is plastic or metallic.

### BRIEF DESCRIPTION OF DRAWINGS

FIG. 1 shows a perspective view of the rattling device 10; including the leg strap 20; belt hanger 30; rounded base body 40 and the striker 90.

FIG. 2 is an exploded view of the rattling device showing more clearly the component parts of the device including the leg strap 20; belt hanger 30; the two component parts of rounded base body—the back plate 60 and the front body 70; the elastic spring 80; and the striker assembly 90.

FIGS. 3A-3D show varying views of the back plate 60. FIG. 3A shows the outside view of the back plate 60 and FIG. 3B shows the inside view of the back plate 60 and the belt hanger 30. FIG. 3C shows the outside view of the back plate with the side tabs 65 and the belt hanger inserted into the back plate. FIG. 3D shows the inside view with the belt hanger inserted and engaged onto the back plate.

FIGS. 4A and 4B show front and back views of the rounded base body 70. FIG. 4B clearly shows the various sized nodes (100, 110, and 120) that are specifically designed to emit low, medium, and high pitched sounds when interacting with the nodes on the striker assembly. FIG. 4A shows slots 130 in the rounded base body where elastic bands or straps that hold the device to the leg can pass.

FIGS. 5A and 5B show front and back views of the striker assembly 90. The striker assembly also has specifically designed nodes (130, 140, and 50) of different sizes which produce high, medium, and low frequency noises when they come in contact with the nodes on the rounded base body. Other key components of the striker are the ribbed finger grip area 160, the palm rest area 180, and the elastic spring seat 200.

FIGS. 6A through 6E depict the interaction of the various nodes when the striker is moved to different locations with respect to the rounded base body. FIG. 6A shows the striker being pulled away from the body, but yet held in tension by the spring 80. This allows a louder sound when the striker is released and the spring action moves it into the body. FIGS. 6A, 6B, and 6C show how the striker can be moved to various locations with respect to the body. Finally, FIG. 6E shows the striker/body assembly in the rest position being held tightly together by the spring and thereby not producing any sound. The flexible elastic spring 80 allows the striker to be moved to any position with relation to the body.

### DETAILED DESCRIPTION OF THE INVENTION

The present invention is directed toward a simple mechanical device that can be used to simulate the rattling sound of the antlers of two bucks clashing against each other during combat. It is a well known fact that the sound of antlers clashing attracts other deer to the area where the sound is being produced. As a hunter progresses through a forest or is perched in a deer stand, there is a requirement that he or she be able to simulate the sound of antlers clashing in order to attract deer to the area. There is a further requirement that the sound be produced only when the hunter wants to produce the sound and not inadvertently. Inadvertent production of simulated antler clashing sounds at inopportune times can scare deer away and/or lead to a less than optimum shot.

While this invention can be used to attract any animal whose adult males engage in combat with antlers (i.e. elk, moose, rams, etc.), for ease of understanding this invention will be discussed in the context of an archery deer hunter.

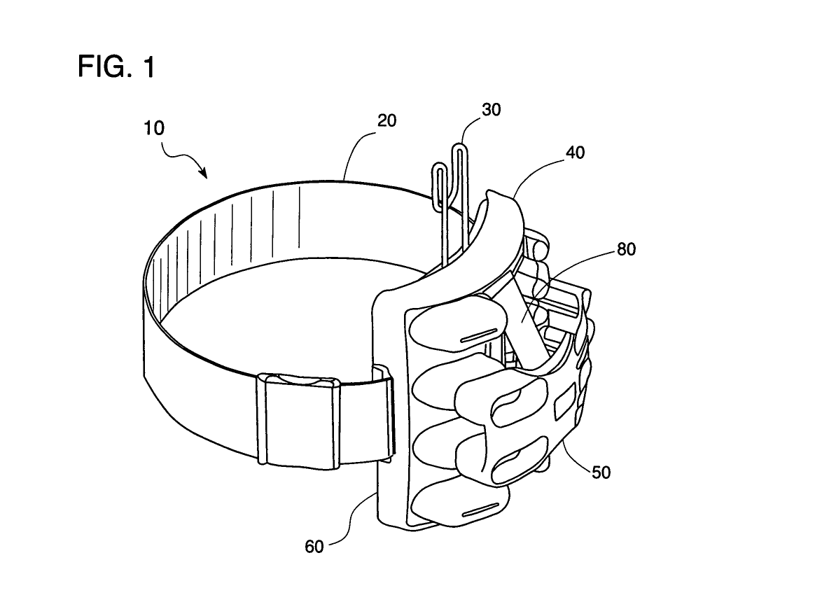

Referring to the figures and in particular to FIG. 1, a perspective view of the assembled deer rattling device 10 is shown. The primary components of the deer rattling device are the leg strap 20, belt hanger 30, rounded base body 40, flexible elastic spring 80, and the striker 90. In the rest position as is shown in FIG. 1, the elastic spring 80 holds the striker assembly tightly and snuggly against the nodes of the rounded base body 40 so that no inadvertent noise is produced. FIG. 1 furthermore shows that there are two methods of attaching the device 10 to the hunter's body or clothing—the leg strap 20 and the belt hanger 30. The combination of these two attachment methods ensures that the device is held firmly and snuggly against the hunter's clothing or body and will not produce any unwanted noise while the hunter is moving.

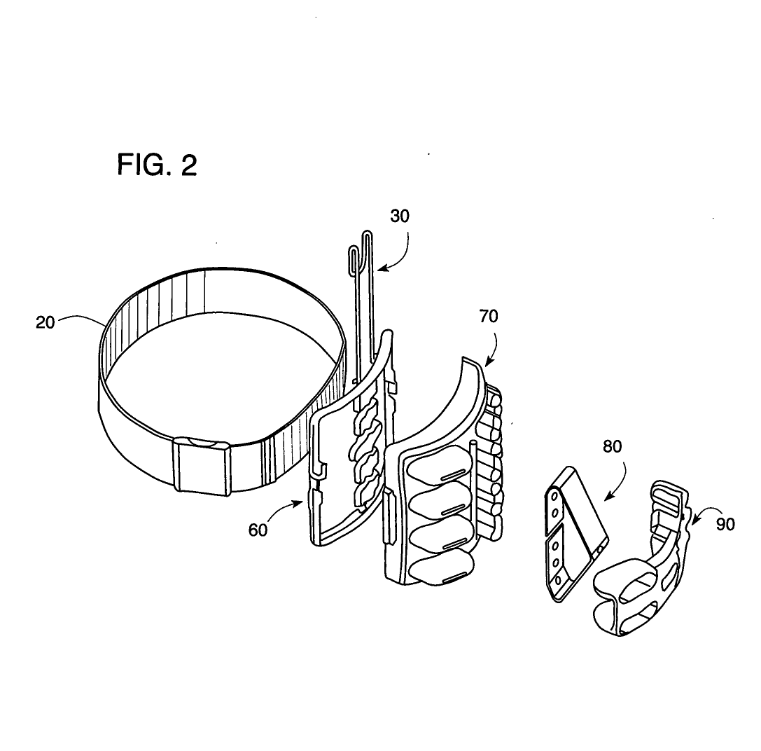

Referring to FIG. 2, an exploded view of the rattling device is shown depicting more clearly the component parts of the device including the leg strap 20; belt hanger 30; the two component parts of rounded base body—the back plate 60 and the front body 70; the elastic spring 80; and the striker assembly 90. The belt hanger 30 is comprised of a metallic wire or durable plastic and is designed to be affixed to the back plate 60 by placing the bottom parts of the hanger through holes in the top of the back base body. The leg strap 20 is adjustable to fit different size upper legs.

The back plate 60 and the front body 70 are designed with tabs and catches so that the two pieces can snap together and hold firmly to form the rounded base body. The flexible spring 80 is generally made from surgical tubing or a similar flexible yet strong material. The material is strong enough to hold the striker 90 tightly against the front body 70 in the rest position, but is flexible enough to allow a hunter to pull the striker away from the front body when he wants to make the sound of bucks engaging their antlers.

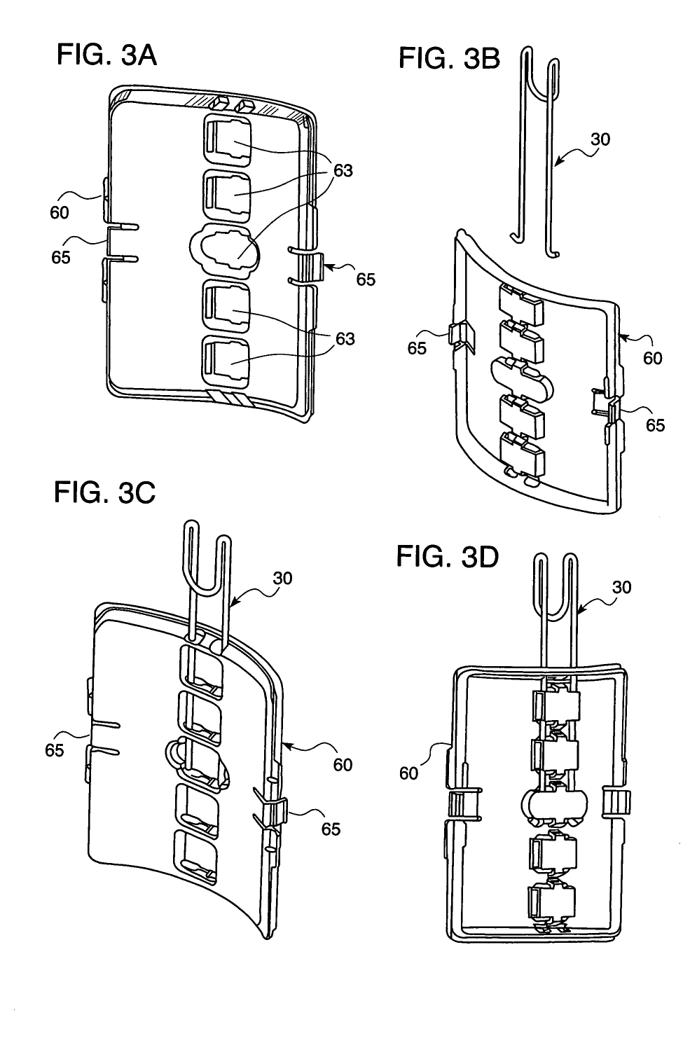

FIGS. 3A-3D show the outside view of the back plate 60. FIG. 3A shows the outside view and FIG. 3B shows the inside view of the back plate 60. FIG. 3C shows the outside view of the back plate with the side tabs 65 and the belt loop hanger 30 and FIG. 3D shows the inside view with the belt loop hanger locked into position in the structure of the back plate.

FIG. 3A also clearly shows the openings/depressions 63 in the back plate 60 that are designed to provide lock holes into which the lock pins on the front body are inserted.

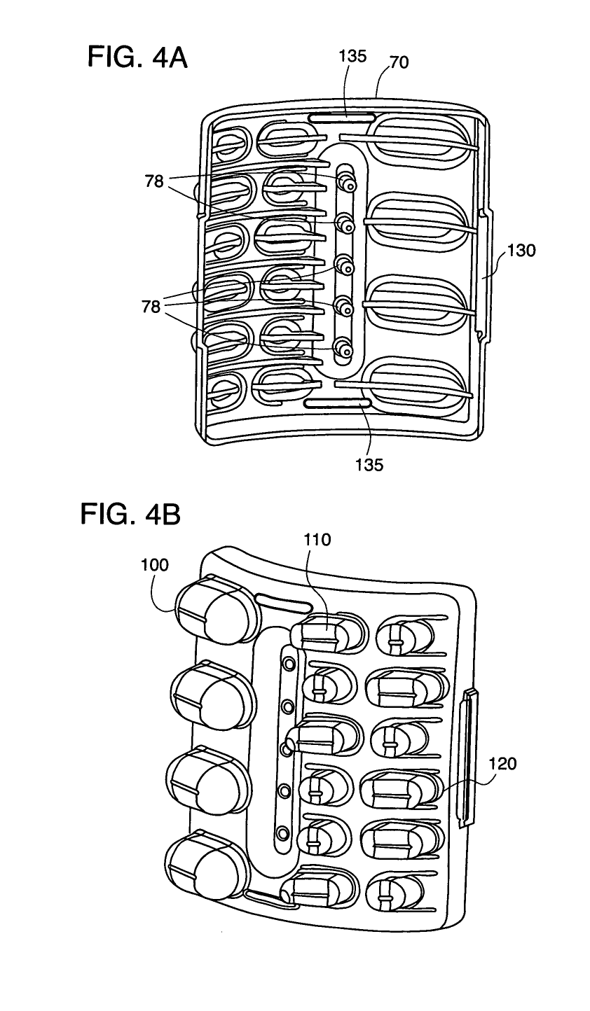

FIGS. 4A and 4B display the front and back views of the front body 70. FIG. 4A shows the anchor pins 78 that join with the lock holes in the back plate to combine the two pieces together to form the curved body. FIG. 4A also shows the slots 135 into which the elastic spring ends fit in order to firm attach the spring to the front body 70.

FIG. 4B shows the nodes that produce the simulated antler rattling noise. The largest nodes 100 produce low pitched tones; the medium sized nodes 110 produce medium pitched tones, and the smallest nodes 120 produce high pitched tones when struck by similar nodes of the striker assembly. The plates and raised nodes are made of injection molded plastic. The raised nodes are hollow on the inside. The hollow nature of the nodes make the device sound exactly like buck antlers clashing together when the striker assembly impinges on the raised nodes of the body. The nodes are curvilinear in nature which results in the nodes glancing off each other much as a buck's antlers would glance off the antlers of another buck.

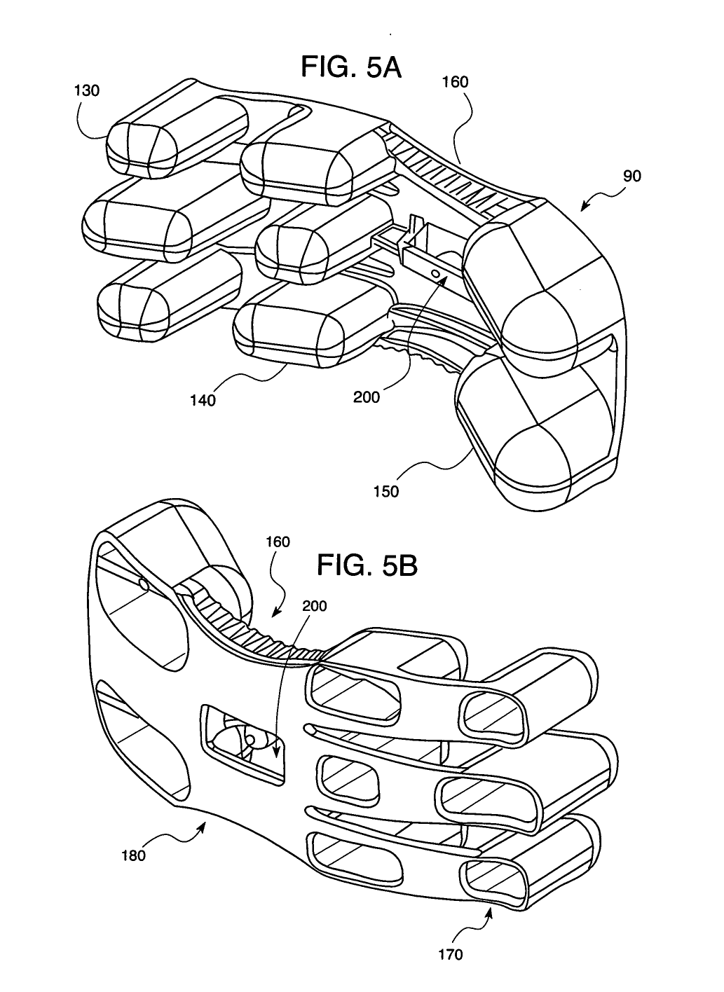

FIGS. 5A and 5B show the front and back sides of the striker assembly 90. Similar to the front body, the striker assembly has three different types of nodes: the largest nodes 150 produce low pitched tones; the medium sized nodes 140 produce medium pitched tones, and the smallest nodes 130 produce high pitched tones when struck by similar nodes of the front body. FIG. 5A also shows the finger grip area 160 of the striker assembly. FIG. 5B shows the palm rest area 180 where the palm of the hunter's hand is placed when the hunter wants to use the device. FIG. 5A also shows the seat for the elastic spring.

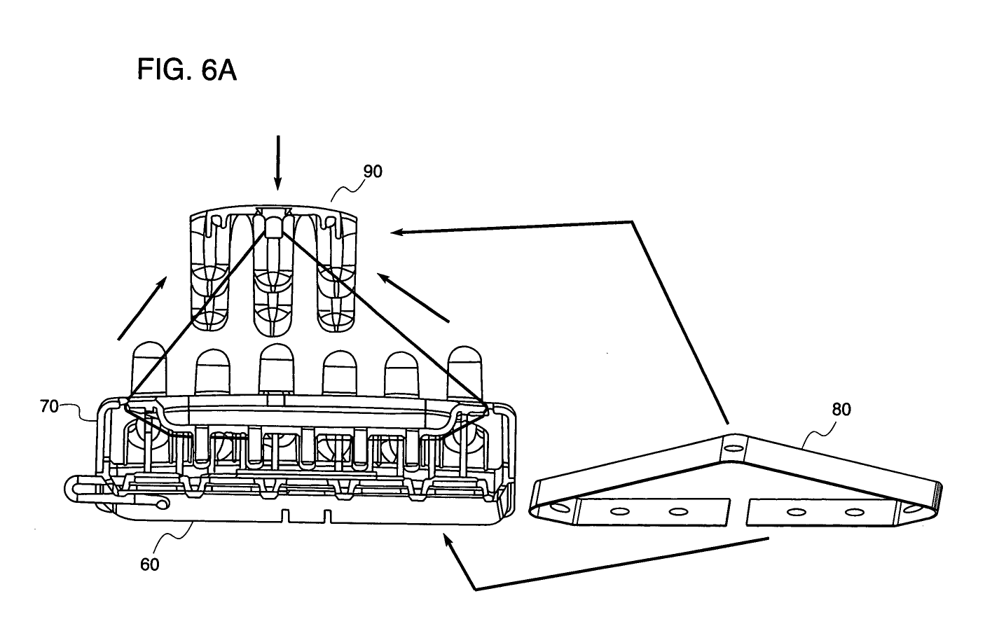

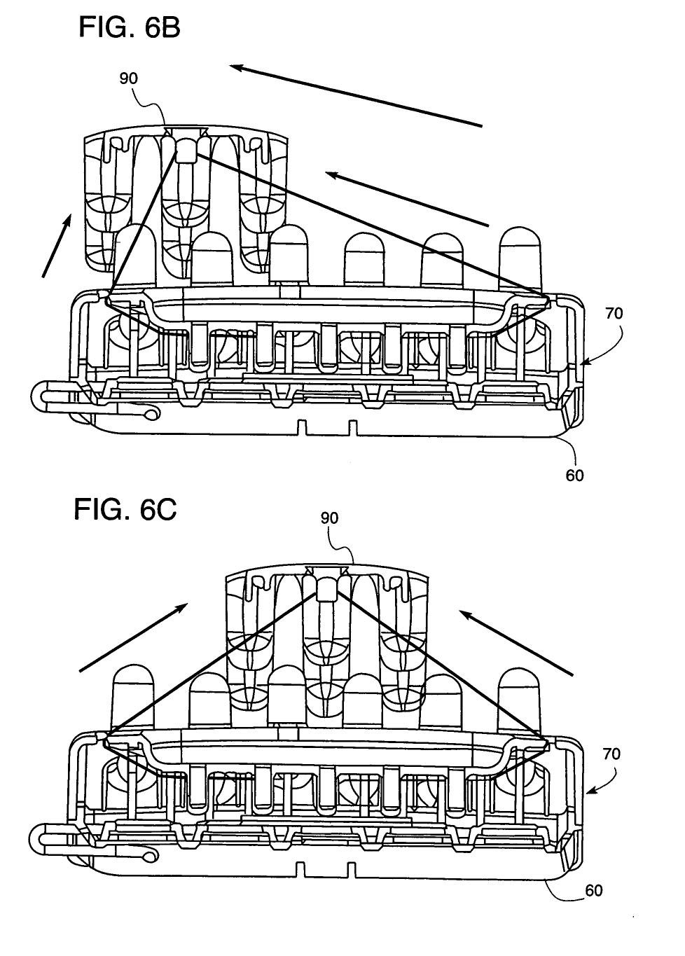

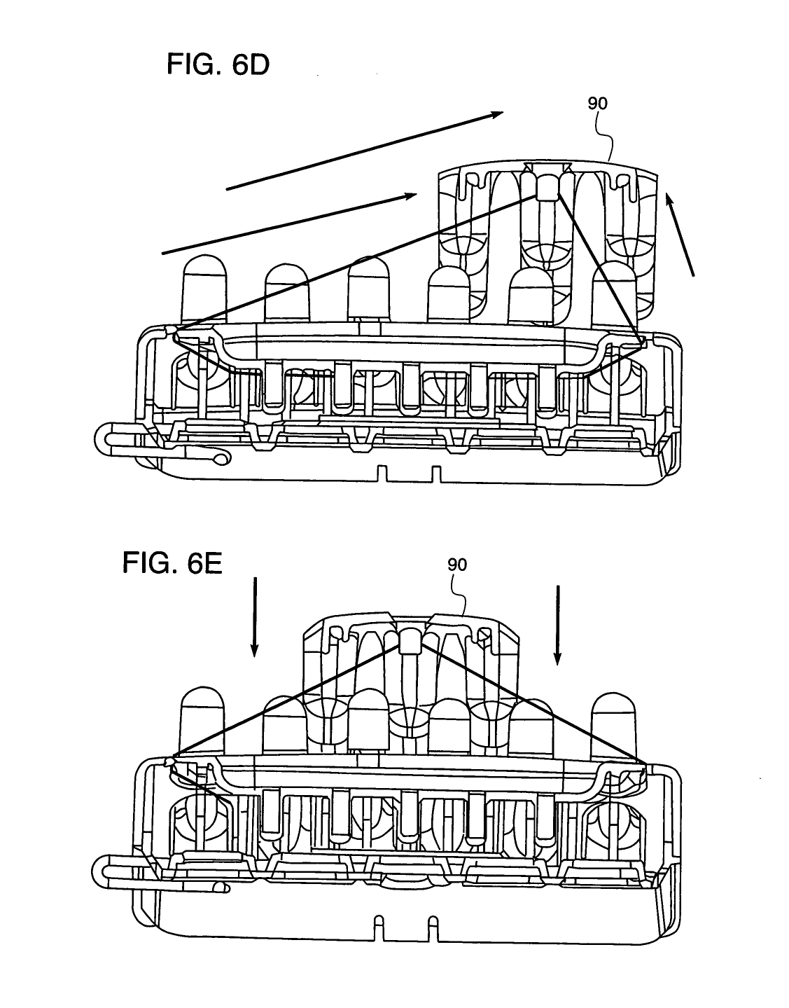

FIGS. 6A through 6E show how the present invention is used by the hunter in the forest. In FIG. 6A, the hunter has grasped the striker assembly 90 and pulled it away from the base plate body. The flexible spring 80 creates an opposite force attempting to move the striker assembly back into the base plate nodes. When the hunter releases the striker, it swiftly moves into the base plate and the nodes of the striker assembly impinge on the nodes of the base plate and create a sound equivalent to that of battling bucks antlers in an initial thrust.

FIGS. 6B, 6C, and 6D show the interaction of the striker nodes with the base plate nodes as the hunter moves the striker in various detentes with respect to the base plate. The hunter rotates the striker assembly slightly thereby moving the nodes against each other and creating a sound that is equivalent to that of battling bucks continuing to engage each other with their antlers. This sound is different than the sharp crack of the initial thrust.

Finally, FIG. 6E shows the device in the rest position wherein the nodes of the striker assembly rest snuggly against the nodes of the base plate and do not move. The tension provided by the spring ensures that the nodes rest snuggly against each other and do not produce an inadvertent sound as the hunter moves through the forest or ascends or descends from a tree stand.

The best mode for making and practicing this invention is to injection mold the curved back and front of the base plate as well as the striker assembly. The key to the effectiveness of the device is to ensure that the base base body and the striker assembly contain a series of variable sized hollow nodes. The device must be assembled such that the nodes face each other with the hollow openings facing away. Another important facet of the invention is the flexible elastic spring which should preferentially be made of a strong flexible material such as surgical tubing. It is important that the elastic spring remain in the elastic domain and not relax or deform with repeated usage.

The following is claimed:

1. A device to produce the simulated sound of animal antlers or horns clashing comprising:
a. a rounded base body containing a series of hollow nodes,
b. a striker assembly containing a series of hollow nodes,
c. an elastic spring holding the rounded base body and the striker assembly together,
d. a leg strap that allows the device to be attached to a person's upper leg,

2. A device as in claim 1 where the rounded base body is contoured to fit the shape of a person's upper thigh.

3. A device as in claim 1 where the hollow nodes of the rounded base body and the striker assembly are of varying sizes to produce varying pitch sounds.

4. A device as in claim 1 where the hollow nodes of the rounded base body face outward and the nodes of the striker assembly face inward so that the nodes face each other.

5. A device as in claim 1 where the rounded base body further comprises a back plate and a front base plate.

6. A device as in claim 1 which further comprises a belt loop hanger.

7. A device as in claim 1 where the elastic spring is made of surgical tubing.

8. A device as in claim 1 where the striker assembly is made of molded plastic.

9. A device as in claim 5 where the back plate and front base plate are made of molded plastic.
